(19) United States
(12) Patent Application Publication
(10) Pub. No.: US 2007/0110493 A1
(43) Pub. Date: May 17, 2007

(54) Media Feeding Device Capable of Detecting Size of Fed Printed Media

(76) Inventor: Chih-Ren Chen, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/557,946

(22) Filed: Nov. 8, 2006

(30) Foreign Application Priority Data
Nov. 11, 2005 (TW) 094139774

(51) Int. Cl. B41J 29/02

(52) U.S. Cl. 400/691

(57) ABSTRACT

A media feeding device capable of detecting the size of the fed media is provided. The claimed media feeding device follows the property of different bit signals, wherein the bit signals are transformed from different rotational angles generated by the rotational shafts, which are pushed by the printed media of different sizes. Therefore, the sizes of the currently fed printed media are detected by the media feeding device rather than informing the media feeding device about the size of the currently fed printed media through manual methods by the user.

### BACKGROUND OF THE INVENTION

1. Field of the Invention

The present invention relates to a media feeding device, and more particularly, to a media feeding device capable of detecting the size of a printed media fed into the media feeding device.

2. Description of the Prior Art

Generally speaking, while a printer having a function of feeding printed media is used, manual operations and an operation panel disposed on the printer are required for selecting a size of required printed media. If the printer is capable of automatically detecting the size of a printed media fed into the printer, a user does not have to manually select the size of the printed media through a computer or an operation panel. It is more convenient for the user to avoid manual operations in favor of the printer automatically detecting the size of the printed media.

Therefore, a light sensor is disposed adjacent to a cartridge for detecting the size of a printed media while the cartridge is moved and the printed media is fed in a prior art printer. However, the cost of the light sensor is significant, and the light sensor is fragile so that the cost of maintaining the function of the light sensor is also significant.

A light-intercepting switch is also utilized in another prior art printer for detecting the size of a printed media fed into the printer. However, a light-intercepting switch can only be utilized for detecting the size of single type of printed media. When it is required for detecting printed media having various types of sizes, the amount of light-intercepting switches is necessarily increased as well as the space for the increased light-intercepting switches. Therefore, the cost of the prior art printer is also increased because of the increased light-intercepting switches.

### SUMMARY OF THE INVENTION

The claimed invention provides a media feeding device for detecting a size of a printed media. The media feeding device comprises a case utilized for depositing a printed media, the case having a plurality of holes, an axle disposed above the case in a rotatable manner, and a plurality of shafts connected to the axle and utilized for driving a rotation of the axle while the plurality of shafts is pushed by the printed media deposited in the case, wherein the plurality of shafts is capable of stretching into the plurality of holes when the plurality of shafts is not pushed by the printed media.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a solid diagram of a media feeding device capable of detecting the size of a printed media while there is no printed media fed into the media feeding device of the present invention.

FIG. 2 is a lateral view of the media feeding device shown in FIG. 1.

FIG. 3 is a bit signal table of a sensing device of the present invention when the sensing device includes two sensing switches.

FIG. 4 is a solid diagram of the media feeding device fed with a printed media having a size of the first type shown in FIG. 3 of the present invention.

FIG. 5 is a lateral diagram of the media feeding device fed with the printed media having a size of the first type shown in FIG. 3 of the present invention.

FIG. 6 is a solid diagram of the media feeding device fed with a printed media having a size of the second type shown in FIG. 3 of the present invention.

FIG. 7 is a lateral diagram of the media feeding device fed with a printed media having a size of the second type shown in FIG. 3 of the present invention.

FIG. 8 is a solid diagram of the media feeding device fed with a printed media having a size of the third type shown in FIG. 3 of the present invention.

FIG. 9 is a lateral view of the media feeding device fed with the printed media having a size of the third type shown in FIG. 3 of the present invention.

FIG. 10 is a combination of a front view and a lateral view of a first sensing device of the present invention.

FIG. 11 is a combination of a front view and a lateral view of the first sensing device of the present invention while generating a two-digit signal (0,1).

FIG. 12 is a combination of a front view and a lateral view of the first sensing device of the present invention while generating a two-digit signal (1,0).

FIG. 13 is a combination of a front view and a lateral view of the first sensing device generating a two-digit signal (1,1) of the present invention.

FIG. 14 is a combination of a front view and a lateral view of a second sensing device of the present invention.

FIG. 15 is a combination of a front view and a lateral view of the second sensing device generating a two-digit signal (0,1) of the present invention.

FIG. 16 is a combination of a front view and a lateral view of the second sensing device generating a two-digit signal (1,0) of the present invention.

FIG. 17 is a combination of a front view and a lateral view of the second sensing device generating a two-digit signal (1,1) of the present invention.

FIG. 18 is a combination of a front view and a lateral view of the second sensing device while the media feeding device of the present invention is fed with a plurality printed media having a size of the first type shown in FIG. 3.

FIG. 19 is a combination of a front view and a lateral view of the second sensing device while a plurality of printed media having a size of the second type shown in FIG. 3 is fed into the media feeding device of the present invention.

FIG. 20 is a combination of a front view and a lateral view of the second sensing device while the media feeding device of the present invention is fed with a plurality of printed media having a size of the third type shown in FIG. 3.

FIG. 21 is a bit signal table of a sensing device having three sensing switches.

### DETAILED DESCRIPTION

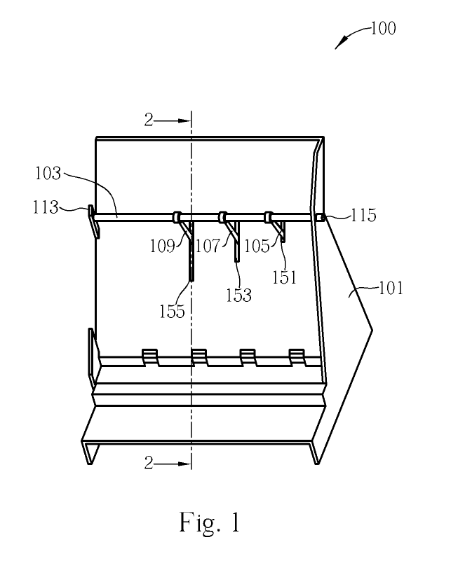

Please refer to FIG. 1, which is a solid diagram of a media feeding device 100 capable of detecting the size of a printed media while there is no printed media fed into the media feeding device 100 of the present invention. The media feeding device 100 comprises a case 101, an axle 103, a plurality of shafts 105, 107, and 109, a retarder 113, and an elastic device 115. The case 101 is utilized for deposit a fed printed media, and has a plurality of holes 151, 153, and 155. The axle 103 is disposed above the case 101 in a rotatable manner. The shafts 105, 107, and 109 are connected to the axle 103 and are capable of stretching into the holes 151, 153, and 155 respectively. The retarder 113 is utilized for restricting an axial movement of the axle 103. The elastic device 115 is utilized for exerting an external force on the axle 103 for driving the shafts 105, 107, and 109 deeply into the plurality of holes 151, 153, and 155. The elastic device 115 may be a torsional spring. When a printed media is fed into the case 101, some shafts of the plurality of shafts 105, 107, and 109 are pushed by the printed media according to the size of the printed media, then a rotation of the axle 103 is driven by the pushed shafts. A rotating angle of the axle 103 can be utilized for indicating a combination of the pushed shafts, therefore, the size of the printed media is also indicated. For example, when a printed media having a smaller size is fed into the case 101, only the shaft 105 is pushed by the smaller printed media; when a printed media having a medium size is fed into the case 101, both the shafts 105 and 107 are pushed by the medium printed media simultaneously; when a printed media having a larger size is fed into the case 101, all the shafts 105, 107, and 109 are pushed by the larger printed media simultaneously. The media feeding device 100 of the present invention may further comprises a sensing device for sensing a rotating angle of the axle 103. After the rotating angle is sensed by the sensing device, the sensed rotating angle along with an indicated size of a corresponding printed media is transmitted to the media feeding device 100 for further processing. A detailed description of the sensing device is provided latter.

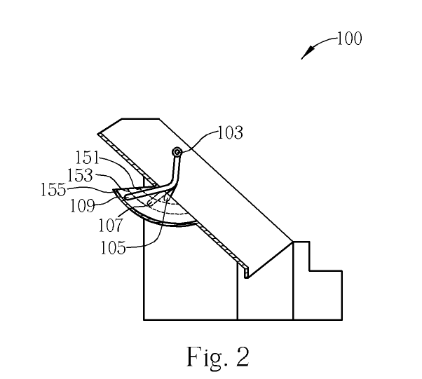

In FIG. 1, when a printed media is fed into the case 101, the printed media must be fed near a side of the case 101, the side being closer to the shaft 105. Therefore, a smaller printed media can only push the shaft 105; a medium printed media can push the shafts 105 and 107 simultaneously; a larger printed media can push the shafts 105,107, and 109 simultaneously; and a combination of the pushed shafts mentioned above is thus generated. For example, in a preferred embodiment of the present invention, a paper of size A6 can only push the shaft 105; a paper of size A5 can only push the shafts 105 and 107 simultaneously; and a paper of size A4 can push the shafts 105, 107, and 109 simultaneously. When a combination of the shafts 105, 107, and 109 is pushed by a printed media, a rotating angle of the axle 103 corresponding to the combination is generated, and a digital signal is also generated for representing the rotating angle of the axle 103 and the combination of the shafts 105, 107, and 109. As shown in FIG. 1, the shafts 105, 107, and 109 correspond to the holes 151, 153, and 155 respectively. The aperture size of the hole 151 is smaller than the aperture size of the hole 153, and the aperture size of the hole 153 is smaller than the aperture size of the hole 155. Assume the shaft 105 has to rotate a rotating angle A1 for moving above a datum plane of the hole 151, the shaft 107 rotates with a rotating angle A2 for moving above a datum plane of the hole 153, and the shaft 109 rotates with a rotating angle A3 for moving above a datum plane of the hole 155. Therefore, the rotating angle A1 is smaller than the rotating angle A2 while the rotating angle A2 is also smaller than the rotating angle A3. Through appropriately setting the aperture sizes of the holes, the size of the printed media fed into the case 101 is determined through the rotating angle of the axle 103 and without confusing the size of the printed media with the other types of printed media having different sizes. Please refer again to the preferred embodiment of the present invention mentioned above. When the shafts 105 and 107 are simultaneously pushed by a fed paper of size A5, the sensing device determines that the rotating angle A2 of the axle 103 is driven by the shaft 107 pushed by the fed paper of size A5 since the paper is no longer in contact with the shaft 105. Similarly, when the shafts 105, 107, and 109 are simultaneously pushed by a fed paper of size A4, the sensing device determines that the rotating angle A3 of the axle 103 is driven by the shaft 109 pushed by the fed paper of size A4 since the shafts 105 and 107 are no longer in contact with the fed paper. Additionally, the amount of printed media deposited in the case 101 is limited for preventing overflow in the case 101 and preventing the axle 103 from rotating by a rotating angle larger than the rotating angle representing the size of the printed media. When the axle 103 rotates by a larger rotating angle than the rotating angle representing the size of the printed media, the size of the printed media is easily mistaken to be a size larger than the printed media. The limitation of the amount of the printed media fed into the case 101 depends on the requirements and the size of the case 101. Moreover, the direction of a section line 2 indicates a lateral view shown in FIG. 2.

As mentioned above, FIG. 2 is a lateral view of the media feeding device shown in FIG. 1. Since no printed media is fed into the case 101 in FIG. 2, the shafts 105, 107, and 109 in FIG. 2 are not pushed into the holes 151, 153, and 155. Note that since FIG. 2 is a lateral view of the media feeding device 100 in FIG. 1, and the section line 2 corresponding to the lateral view lies on the hole 155, thereby, the holes 151 and 153 are not visible in FIG. 2 so that the depths and the opening lengths of the holes 151 and 153 are shown in dotted lines.

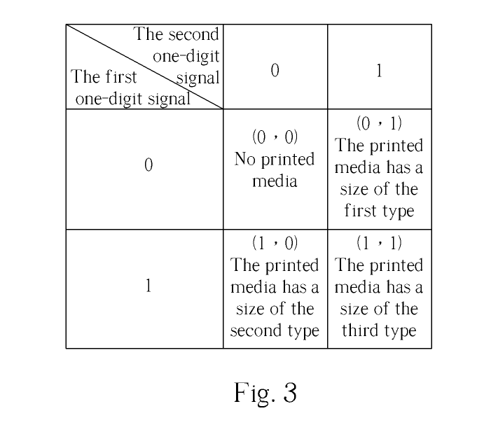

Please refer to FIG. 3. As mentioned above, the media feeding device 100 of the present invention further comprises a sensing device for detecting a rotating angle of the axle 103 driven by the shafts pushed by the printed media. FIG. 3 is a bit signal table of the sensing device when the sensing device includes two sensing switches. From the description in FIG. 1, when the shafts are pushed by the fed printed media, the axle 103 simultaneously rotates in an angle, which is transformed into a two-digits signal latter for representing the size of the fed printed media. Note that the sizes of the printed media correspond to different rotating angles of the axle 103 respectively. When the sensing device senses the rotating angle of the axle 103, each of the sensing switches of the sensing device generates a bit signal of value 0 or 1 according to whether the corresponding sensing switch is triggered. Lastly, the sensing device integrates both the digital signals generated by the sensing switches respectively to form a two-digit signal, which represents the size of the printed media. As shown in FIG. 3, when the sensing device includes two sensing switches, four different statuses are generated for representing three types of sizes of the printed media and the instance when there is no printed media in the case 101. For example, since there is no printed media fed into the media feeding device 100, no sensing switches are triggered so that both the sensing switches generate a digital signal of value 0. Then the sensing device integrates both the digital signals into a two-digit signal (0,0) for representing the instance when there is no printed media in the media feeding device 100. In the example, the number of sensing switches corresponds to the types of the sizes of the printed media. When the number of the sensing switches is N, which is a positive integer, the number of the types of the sizes of the printed media is (2^{N}−1). The media feeding device 100 may further include different sensing devices for detecting the rotating angle of the axle 103 pushed by the printed media.

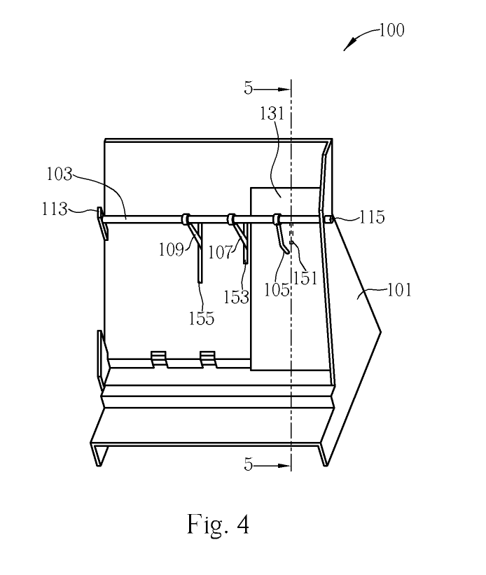

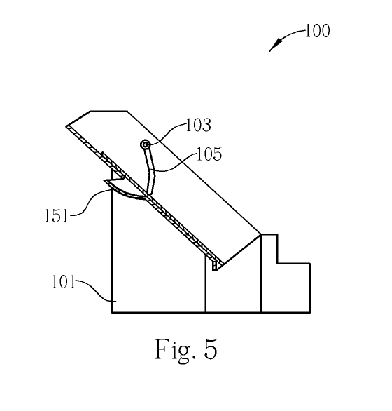

FIG. 4 is a solid diagram of the media feeding device 100 fed with a printed media 131. As shown in FIG. 4, the shaft 105 is pushed by the printed media 131. Since the size of the printed media 131 is smaller, the shafts 107 and 109 are not pushed by the printed media 131. In this situation, a sensing device including two sensing switches, the sensing device not shown in FIG. 4, generates a two-digit signal (0,1) for representing the size of the printed media 131. Moreover, the section line 5 shown in FIG. 4 indicates a lateral view of FIG. 5.

FIG. 5 is a lateral diagram of the media feeding device 100 fed with the printed media 131. As shown in FIG. 5, the shaft 105 is pushed out of the hole 151 by the printed media 131. Note that FIG. 5 is a lateral view of the media feeding device shown in FIG. 4, and the section line of FIG. 4 lies on the hole 151, thereby, in FIG. 5, the holes 153 and 155 are not visible and the shafts 107 and 109 are not visible.

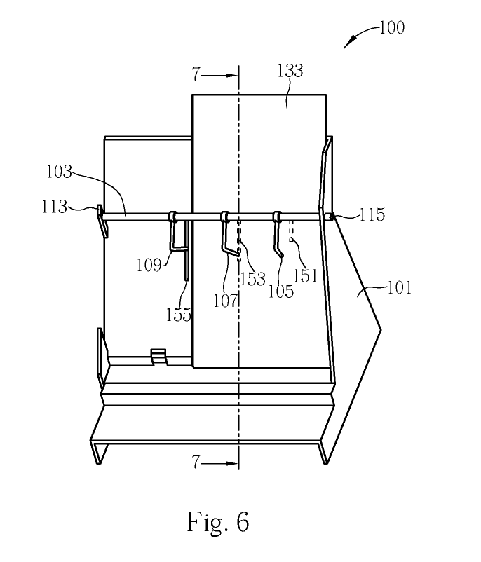

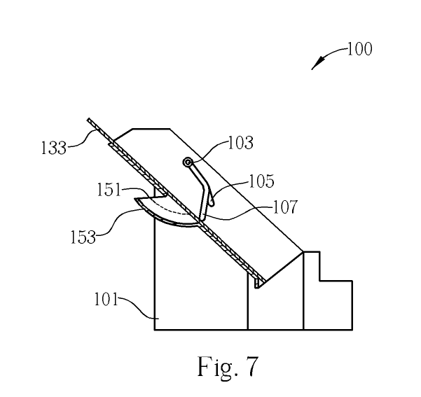

FIG. 6 is a solid diagram of the media feeding device 100 fed with a printed media 133. As shown in FIG. 6, the shafts 105 and 107 are pushed by the printed media 133. Since the size of the printed media 133 is medium (i.e., not small and not large), only the shaft 109 is not pushed by the printed media 133. Under this situation, a sensing device, which is not shown in FIG. 6, including two sensing switches correspondingly generates a two-digit signal (1,0) for representing the size of the printed media 133. Moreover, the section line 7 indicates a lateral view of FIG. 7.

FIG. 7 is a lateral diagram of the media feeding device 100 fed with a printed media 133. As shown in FIG. 7, the shafts 105 and 107 are pushed out of the holes 151 and 153 respectively by the printed media 133. Note that FIG. 7 is a lateral diagram of the media feeding device 100 shown in FIG. 6, and the section line 7 lies on the hole 153. Therefore, the hole 155 and the shaft 109 are not visible in FIG. 7, and the opening length and the depth of the hole 151 is illustrated with a dotted line.

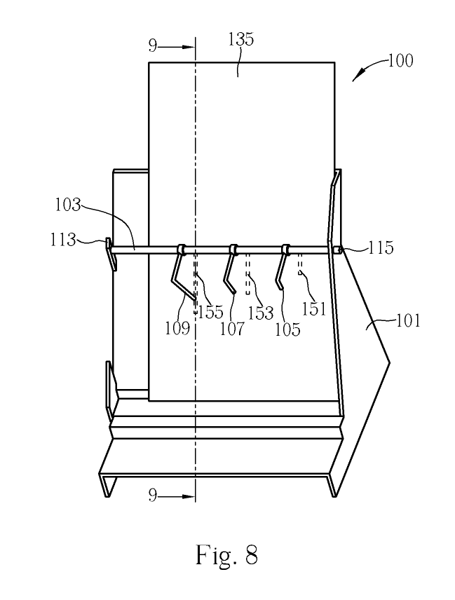

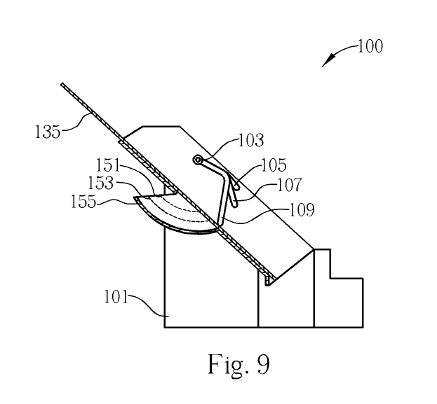

FIG. 8 is a solid diagram of the media feeding device 100 fed with a printed media 135. As shown in FIG. 8, the shafts 105, 107, and 109 are pushed by the printed media 135. Under this situation, a sensing device, which is not shown in FIG. 8, including two sensing switches correspondingly generates a two-digit signal (1,1) for representing the size of the printed media 135. Moreover, the section line 9 shown in FIG. 8 indicates a lateral view in FIG. 9.

FIG. 9 is a lateral view of the media feeding device 100 fed with the printed media 135. As shown in FIG. 9, the shafts 105, 107, and 109 are pushed out of the holes 151, 153, and 155 respectively by the printed media 135. Note that FIG. 9 is a lateral diagram of the media feeding device 100 shown in FIG. 8 with respect to the section line 9, which lies on the hole 155, therefore, the opening lengths and the depths of the holes 151 and 153 are illustrated with dotted lines.

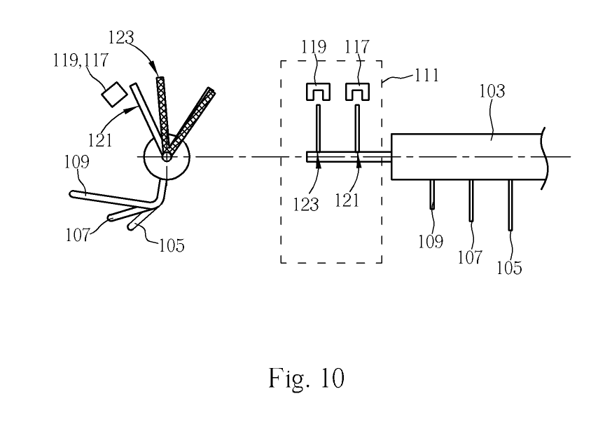

Please refer to FIG. 10, which is a combination of a front view and a lateral view of a first embodiment of the sensing device of the present invention. In FIG. 10, there is no printed media fed into the media feeding device 100. The sensing device 111 comprises two sensing switches 117 and 119, two shafts 121 and 123, and an extension of the axle 103. The shafts 121 and 123 are utilized for indicating the rotations of the shafts 105, 107, and 109 so that both the sensing switches 117 and 119 are able to detect the corresponding rotating angles. While the shafts 121 and 123 rotate by a specific angle, the shafts 121 and 123 trigger the sensing switches 117 and 119 respectively, therefore, the rotating angle of the axle 103 driven by the shafts 105, 107, and 109 is transformed into a two-digit signal representing the size of the fed printed media. The two-digit signal represents the detected size of the printed media, then the media feeding device 100 executes preceding procedures related to the fed printed media. In a preferred embodiment of the present invention, the sensing switches 117 and 119 may be touch-sensing switches or light-sensing switches. In FIG. 10, since there is no printed media fed in the case 101 of the media feeding device 100, the sensing switches 117 and 119 are not triggered by the shafts 121 and 123, and a two-digit signal (0,0) is thus generated by the sensing device 111. The first 0 of the two-digit signal (0,0), i.e., the least significant digit 0 of (0,0), represents that the sensing switch 117 is not triggered by the shaft 121. The second 0 of the two-digit signal (0,0), i.e., the most significant digit 0 of (0,0), represents that the sensing switch 119 is not triggered by the shaft 123. Note that in the sensing device 111, part of the shaft 121 overlaps with part of the shaft 123. Therefore, dots are utilized for painting the shaft 123 in the lateral view to distinguish from the shaft 121.

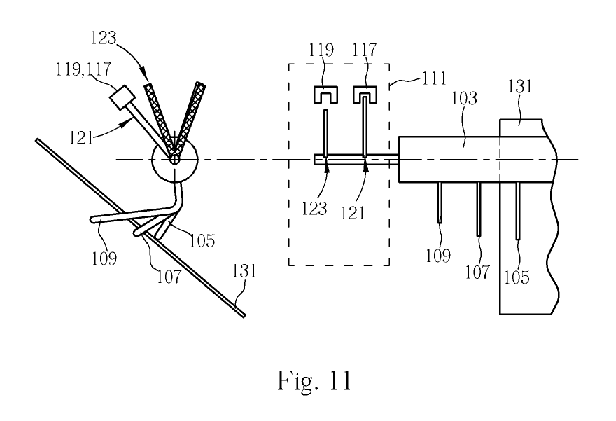

FIG. 11 is a combination of a front view and a lateral view of the sensing device 111 of the present invention while generating a two-digit signal (0,1). When a printed media 131 is fed into the media feeding device 100, the shaft 105 is pushed by the printed media 131, thereby, the shafts 121,123 and the axle 103 are rotated in an angle as shown in FIG. 11. The sensing switch 117 is thus triggered by the shaft 121, and a one-digit signal “1” is also generated. The sensing switch 119 is not triggered by the shaft 123, and a one-digit signal “0” is generated. The sensing device 111 then combines both digits for generating a two-digit signal (0,1) and transmits the two-digit signal to the media feeding device 100 thereby informing the media feeding device 100 that the size of the printed media 131 fed into the media feeding device 100 is the first type shown in FIG. 3. Similarly, in the sensing device 111 shown in FIG. 11, part of the shaft 121 overlaps with part of the shaft 123. Therefore, dots are plotted on the shaft 123 for distinguishing from the shaft 121 in the lateral view.

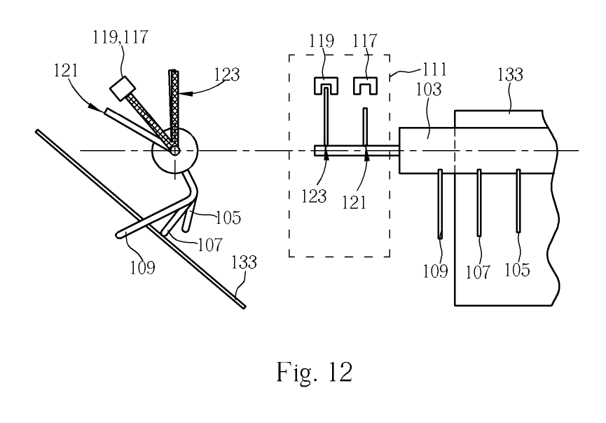

FIG. 12 is a combination of a front view and a lateral view of the sensing device 111 of the present invention while generating a two-digit signal (1,0). When a printed media 133 is fed into the media feeding device 111, the shafts 105 and 107 are pushed by the printed media 133. Therefore, the axle 103 and the shafts 121,123 are driven to rotate in an angle, and the sensing switch 119 is triggered by the shaft 123 to generate a one-digit signal “1”. Although the sensing switch 117 is temporarily triggered by the shaft 121, however, the shaft 121 continues rotating and thus leaving the triggering range of the sensing switch 117. Therefore, a one-digit signal “0” is generated at last from the sensing switch 117. The sensing device 111 then combines both the one-digit signals to generate a two-digit signal (1,0) and transmits the two-digit signal (1,0) to the media feeding device 100 for informing the media feeding device 100 that the size of the printed media 133 is the second type shown in FIG. 3. Similarly, in the sensing device 111 of the present invention, part of the shaft 121 overlaps with part of the shaft 123, therefore, dots are plotted on the shaft 123 for distinguishing from the shaft 121 in the lateral view.

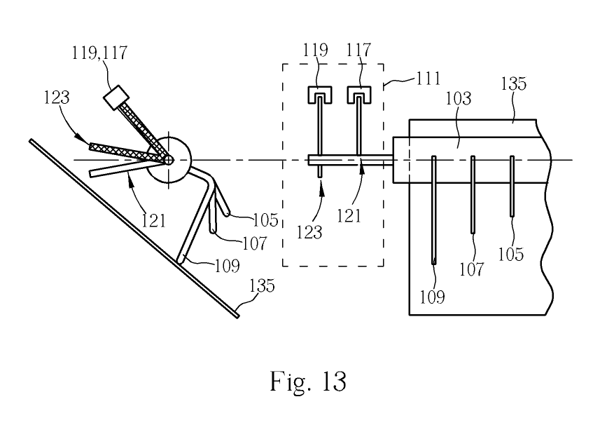

Please refer to FIG. 13, which is a combination of a front view and a lateral view of the sensing device 111 generating a two-digit signal (1,1) in the present invention. When the media feeding device 100 of the present invention is fed with a printed media 135, the shafts 105, 107, and 109 are pushed by the printed media 135 and drive a rotation of the shafts 121, 123 and the axle 103 as shown in FIG. 13. Therefore, the shaft 121 is triggered by the sensing switch 117 and generates a one-digit signal “1”. Similarly, the sensing switch 119 is triggered by the shaft 123 and generates a one-digit signal “1”. The sensing device 111 combines both the one-digit signals and generates a two-digit signal (1,1) for transmitting the two-digit signal (1,1) to the media feeding device 100 of the present invention for informing the media feeding device 100 that the size of the printed media 135 is the third type shown in FIG. 3. Similarly, in the sensing device 111 of the present invention, part of the shaft 121 overlaps with part of the shaft 123. Therefore, dots are plotted on the shaft 123 for distinguishing from the shaft 121 in the lateral view.

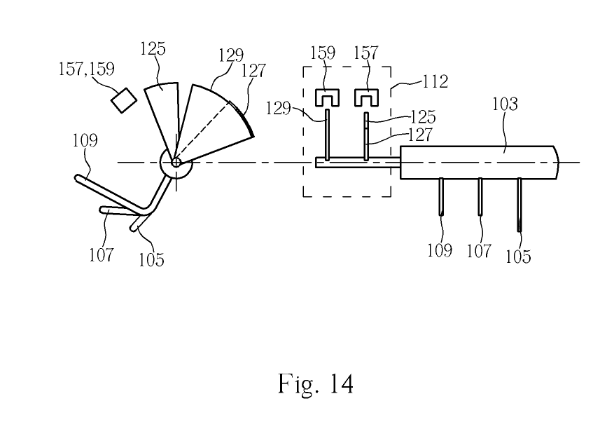

FIG. 14 is a combination of a front view and a lateral view of the sensing device 112 of the present invention. In FIG. 14, the media feeding device 100 is not fed with any printed media. The sensing device 112 comprises two sensing switches 157 and 159, three fan-shaped levers 125, 127, and 129, and an extension of the axle 103. The fan-shaped levers 125, 127, and 129 are utilized for indicating a rotation of the shafts 105, 107, and 109 so that the sensing switches 157 and 159 sense the rotation of the shafts 105, 107, and 109. A rotation of the fan-shaped levers 125 and 127 are coaxial, therefore, both the fan-shaped levers 125 and 127 may trigger the sensing switch 157. A rotation of the fan-shaped lever 129 may trigger the sensing switch 159. Therefore, a rotating angle of the axle 103 driven by the shafts 105, 107, and 109 is transformed into a two-digit signal, which indicates the size of the printed media fed into the media feeding device 100. Please refer to the lateral view shown in FIG. 14 again, the sensing switch 157 overlaps with the sensing switch 159. In a preferred embodiment, the sensing switches 157 and 159 may be touch sensors or light sensors. In FIG. 14, since the case 101 of the media feeding device 100 is not fed with any printed media, the fan-shaped levers 125, 127, and 129 are not pushed to trigger the sensing switches 157 and 159, and a two-digit signal (0,0) is thus generated from the sensing device 112. The least significant digit “0” in the two-digit signal (0,0) indicates that the sensing switch 157 is not triggered by the fan-shaped levers 125 and 127, whereas the most significant digit “0” in the two-digit signal (0,0) indicates that the sensing switch 159 is not triggered by the fan-shaped lever 129.

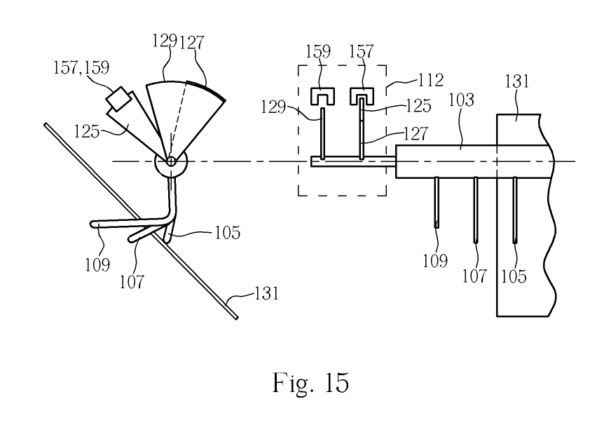

Please refer to FIG. 15, which is a combination of a front view and a lateral view of the sensing device 112 generating a two-digit signal (0,1) in the present invention. When the printed media 131 is fed into the media feeding device 100 of the present invention, the shaft 105 is pushed by the printed media 131. Therefore, as shown in FIG. 15, the fan-shaped lever 125 rotates in a rotating angle and triggers the sensing switch 157 for generating a one-digit signal “1”. The fan-shaped lever 127 does not trigger the sensing switch 157 since the rotating angle of the fan-shaped lever 127 does not reach the sensing switch 157. The rotating angle of the fan-shaped lever 129 does not reach the sensing switch 159 either, thereby, a one-digit signal “0” is generated from the sensing switch 159. Then the sensing device 112 combines both the one-digit signals to generate a two-digit signal (0,1) and transmits the two-digit signal (0,1) to the media feeding device 100 for informing the media feeding device 100 that the size of the printed media 131 is the first type shown in FIG. 3.

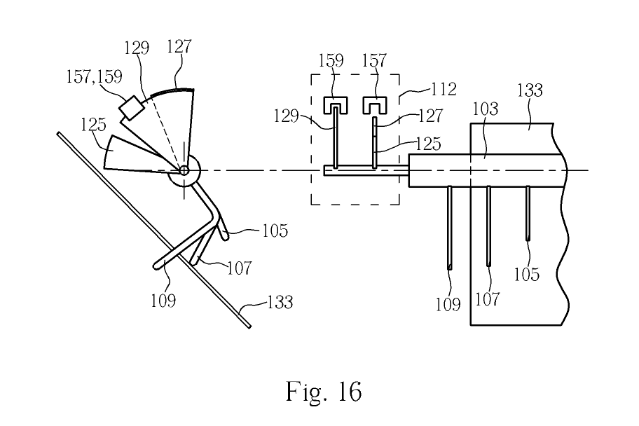

FIG. 16 is a combination of a front view and a lateral view of the sensing device 112 generating a two-digit signal (1,0) of the present invention. When the printed media 133 is fed into the media feeding device 100 of the present invention, the shafts 105 and 107 are pushed by the printed media 133. Therefore, the axle 103 and the fan-shaped levers 125, 127 are driven to rotate in a rotating angle by the shafts 105 and 107. Then the fan-shaped lever 129 is triggered by the sensing switch 159 to generate a one-digit signal “1”. However, the sensing switch 157 is triggered by the fan-shaped lever 125 only temporarily, and the fan-shaped lever 125 continues rotating and thereby later leaves the triggering range of the sensing switch 157. Thereby, a one-digit signal “0” is generated from the sensing switch 157 at last. The rotating angle of the fan-shaped lever 127 does not reach the triggering range of the sensing switch 157. The sensing device 112 combines both the one-digit signals into a two-digit signal (1,0) and transmits the two-digit signal (1,0) to the media feeding device 100 for informing the media feeding device 100 that the size of the printed media 133 is the second type shown in FIG. 3.

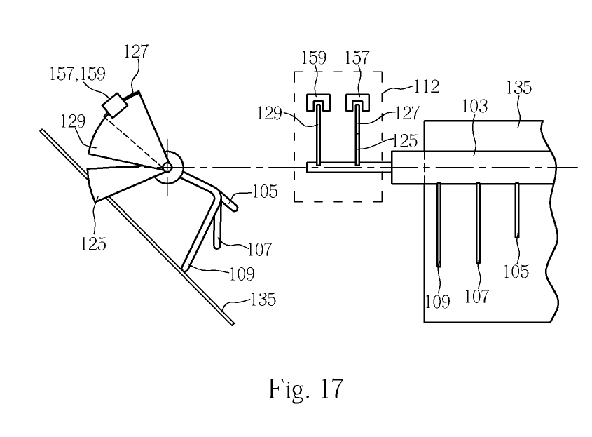

Please refer to FIG. 17, which is a combination of a front view and a lateral view of the sensing device 112 generating a two-digit signal (1,1) of the present invention. When the printed media 135 is fed into the media feeding device 100, the shafts 105, 107, and 109 are pushed by the printed media 135, thereby, the fan-shaped levers 125, 127, and 129 are driven to rotate a rotating angle as shown in FIG. 17. The fan-shaped lever 129 is triggered by the sensing switch 159 to generate a one-digit signal “1”. The sensing switch 157 is triggered by the fan-shaped lever 125 only temporarily, and the fan-shaped lever 125 continues rotating and thereby later leaves the triggering range of the sensing switch 157. The fan-shaped lever 127 is triggered by the sensing switch 157 to generate a one-digit signal “1”. Then the sensing device 112 combines generate a two-digit signal (1,1) and transmits the two-digit signal (1,1) to the media feeding device 100 for informing the media feeding device 100 that the size of the printed media 135 is the third type shown in FIG. 3.

When a plurality of printed media is fed into the media feeding device of the present invention, the shafts of media feeding device rotate in a larger rotating angle. However, through appropriate designs, the size of the plurality of printed media is still recognized by the media feeding device of the present invention according to the larger rotating angle.

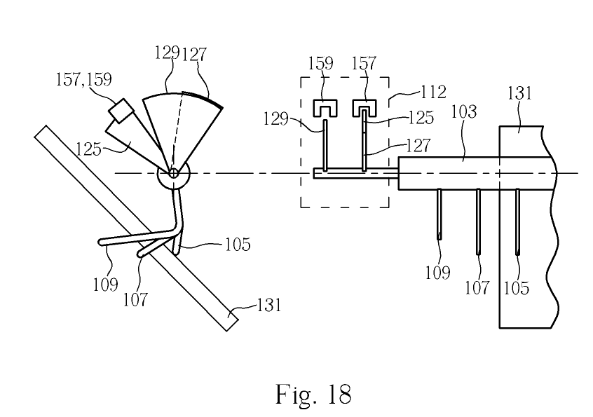

Please refer to FIG. 18, which is a combination of a front view and a lateral view of the sensing device 112 while the media feeding device 100 is fed with a plurality printed media 131 of the present invention. As shown in FIG. 18, the shaft 105 is pushed by the plurality of printed media 131. Since the thickness of the plurality of printed media 131 is larger than single printed media 131, the shaft 105 rotates by a larger rotating angle in FIG. 18 than in FIG. 15. According to specifications of the sensing device 112 of the present invention, although the rotating angles of the fan-shaped levers 125, 127, and 129 become larger, the rotation of the fan-shaped levers 125, 127, and 129 is still detectable for the sensing switches 157 and 159 of the sensing device 112. That is, through proper designs, the sensing device of the media feeding device of the present invention is capable of detecting the sizes of a plurality of printed media fed into the media feeding device of the present invention. Therefore, the sensing device 112 generates a two-digit signal (0,1) for indicating the sizes of the plurality of printed media 133 are the first type shown in FIG. 3.

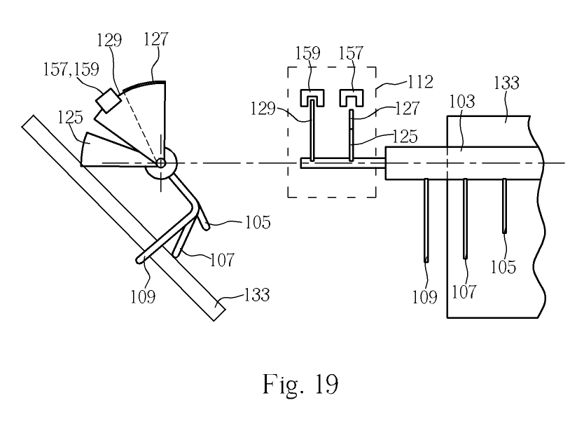

FIG. 19 is a combination of a front view and a lateral view of the sensing device 112 while a plurality of printed media 133 is fed into the media feeding device 100 of the present invention. Similarly, the shafts 105 and 107 are pushed by the plurality of printed media 133 and rotate by a larger rotating angle in FIG. 19 than in FIG. 16. According to specifications of the sensing device 112, the rotating angles of the fan-shaped levers 125, 127, and 129 driven by the axle 103 are still detectable for the sensing switches 157 and 159 of the sensing device 112. Therefore, a two-digit signal (1,0) is generated from the sensing device 112 for indicating the sizes of the plurality of printed media 133 are the second type shown in FIG. 3.

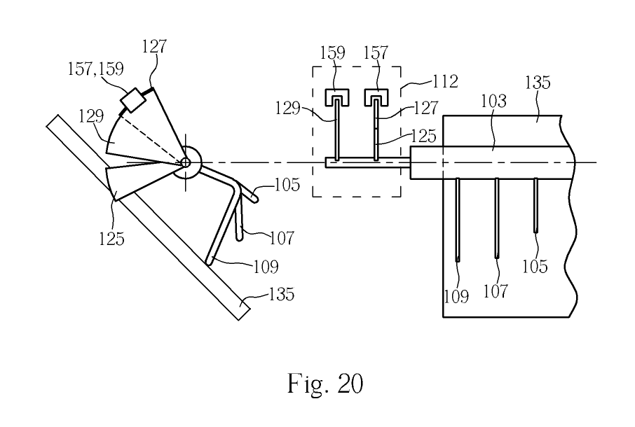

FIG. 20 is a combination of a front view and a lateral view of the sensing device 112 while the media feeding device 100 is fed with a plurality of printed media 135. Similarly, the shafts 105, 107, and 109 are pushed by the plurality of printed media 135 and rotate by a larger rotating angle in FIG. 20 than in FIG. 17. According to specifications of the sensing device 112 of the present invention, the rotating angles of the fan-shaped levers 125, 127, 129 driven by the axle 103 are still detectable for the sensing switches 157 and 159 of the sensing device 112. Therefore, a two-digit signal (1,1) is generated from the sensing device 112 for indicating the sizes of the plurality of the printed media 135 are the third type shown in FIG. 3.

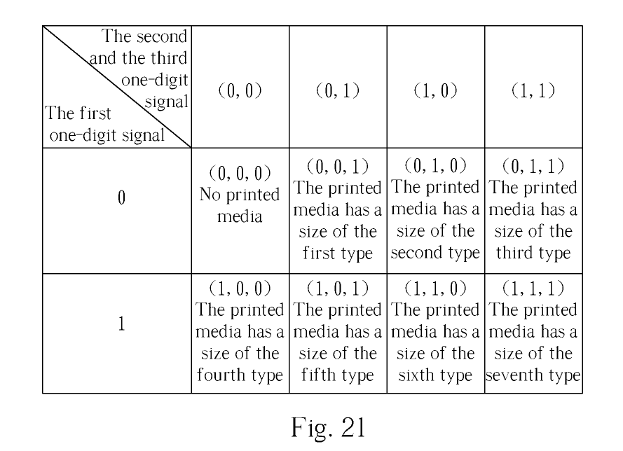

Sensing devices capable of detecting additional sizes of the printed media fed into the media feeding device of the present invention may also be utilized in the present invention. Please refer to FIG. 21, which is a bit signal table of a sensing device having three sensing switches. As shown in FIG. 21, the sensing device having three sensing switches is capable of detecting various sizes of the printed media fed into the media feeding device such as (0,0,0), (0,0,1), (0,1,0), (0,1,1), (1,0,0), (1,0,1), (1,1,0), and (1,1,1), i.e., the sensing device is capable of detecting seven types of sizes of the printed media whereas (0,0,0) indicates that there is no printed media fed into the media feeding device of the present invention. Similarly, by utilizing a sensing device having more sensing switches, the media feeding device of the present invention is capable of detecting even more sizes of the printed media fed into the media feeding device of the present invention.

In the present invention, various rotating angles of shafts and levers are utilized for indicating various sizes of printed media while the printed media push the shafts and thus trigger sensing switches of the sensing device. The present invention enables a general printer to automatically detect the size of the printed media fed into the media feeding device for facilitating preceding processes on the printed media. Manual settings for setting the size of the printed media fed into the printer are thereby unnecessary. Additionally, the number of sensing switches in a traditional sensing device equals the number of sizes of the printed media that the sensing device can detect. However, the number of sizes of the printed media is logarithmically proportional to the number of sensing switches in the present invention. In other words, utilizing the same number of sensing switches, the sensing device of the present invention detects more sizes of printed media than the traditional sensing device. Therefore, the sensing device of the present invention saves expense and facilitates the efficiency of the media feeding device of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A media feeding device for detecting a size of a printed media, the media feeding device comprising:
a case utilized for depositing a printed media, the case having a plurality of holes;
an axle disposed above the case in a rotatable manner; and
a plurality of shafts connected to the axle and utilized for driving a rotation of the axle while the plurality of shafts is pushed by the printed media deposited in the case, wherein the plurality of shafts is capable of stretching into the plurality of holes when the plurality of shafts is not pushed by the printed media.

2. The media feeding device of claim 1 further comprising a sensing device utilized for detecting a rotating angle of the axle, the sensing device comprising:
a plurality of light sources;
a plurality of sensors, each sensor utilized for sensing light emitted from a corresponding light source; and
a plurality of levers connected to the axle, each lever rotating a corresponding angle while the axle is rotating;
wherein the plurality of levers shade the plurality of sensors from the light emitted from the plurality of light sources.

3. The media feeding device of claim 2 wherein the plurality of levers is fan-shaped.

4. The media feeding device of claim 1 further comprising a sensing device utilized for sensing a rotating angle of the axle, the sensing device comprising:
a plurality of touch sensors; and
a plurality of levers connected to the axle, each lever rotating a corresponding angle when the axle rotates;
wherein the plurality of levers touch the touch sensors after the plurality of levers rotates a specific angle.

5. The media feeding device of claim 4 wherein the plurality of levers is fan-shaped.

6. The media feeding device of claim 1 further comprising an elastic device coupled to the axle and utilized for exerting an external force on the axle for pushing the plurality of shafts into the plurality of holes.

7. The media feeding device of claim 6 wherein the elastic device is a torsional spring.

8. The media feeding device of claim 1 wherein the plurality of holes is a plurality of trenches.

9. The media feeding device of claim 1 wherein the plurality of shafts is bended.
